(19) United States
(12) Patent Application Publication
(10) Pub. No.: US 2024/0055909 A1
(43) Pub. Date: Feb. 15, 2024

(54) METHOD FOR OPERATING A WIRELESS TRANSMISSION DEVICE FOR DETECTING AND PREVENTING UNDESIRED EMISSIONS OF HIGH-FREQUENCY FIELDS

(71) Applicant: Robert Bosch GmbH, Stuttgart (DE)

(72) Inventor: Michael Mahler, Leinfelden-Echterdingen (DE)

(21) Appl. No.: 18/260,636

(22) PCT Filed: Dec. 10, 2021
(86) PCT No.: PCT/EP2021/085142

§ 371 Date: Aug. 22, 2023

(30) Foreign Application Priority Data
Jan. 11, 2021 (DE) 10 2021 200 177.7

(51) Int. Cl. H02J 50/70; H02J 50/60; H02J 50/80; H02J 50/10; B60L 53/122; B60L 53/124

(52) U.S. Cl. CPC H02J 50/70; H02J 50/60; H02J 50/80; H02J 50/10; B60L 53/122; B60L 53/124

(57) ABSTRACT

The invention relates to a method for operating a wireless energy transmission device (1), for example for charging an energy storage device (2) of an electric vehicle, comprising at least one transmission coil (4), which is suitable for an inductive energy transmission and which comprises a transmission coil control unit (5), and at least one receiving coil (6), which is suitable for an energy transmission and which comprises a receiving coil control unit (7). The wireless transmission device additionally comprises at least one first measuring element (8) and a first measuring device (9) which is connected to the measuring element, wherein in a first step, the field strength in an air gap (10) between the transmission coil (4) and the receiving coil (6) is measured by the at least one measuring device (9) using the measuring element (8), and, in a second step, the transmission coil control unit (5) sets the working point of the energy transmission while taking into consideration the field strength value measured by the measuring element (8) such that the degree of efficiency of the energy transmission device (1) is maximized.

### BACKGROUND

The invention relates to a method for operating a wireless energy transmission device, for example for charging an energy storage device of an electric vehicle, comprising a transmission coil, which is suitable for an inductive energy transmission, the inductive energy transmission device further comprising a measuring device having a measuring element. Furthermore, the inductive energy transmission device comprises a receiving coil, which is suitable for an inductive energy transmission and which comprises a receiving coil control unit, the inductive energy receiving device further comprising a measuring device having a measuring element. By means of the measuring element, the field strength of the alternating magnetic field in an air gap between the transmission coil and the receiving coil is measured in connection with the first measuring device. Based on the measured result achieved, the transmission coil control unit sets a working point of the energy transmission device, taking into consideration the field strength value measured by the measuring element such that a degree of efficiency of the energy transmission device is maximized.

Wireless transmission of electrical energy for supplying power to electrical devices and/or for charging battery-electrically powered devices presents the problem that inductive energy transmission emits a portion of the transmitted energy into the surrounding space. Only a portion of the energy emitted is received by the receiver side and converted back into electrical energy. The remaining portion of the energy emitted is lost to the energy transmission and causes undesirable effects in the vicinity of the wireless inductive energy transmission device.

Document EP 2 332 231B1 describes an inductive charger which inductively supplies energy to one or more battery-powered devices, each device comprising a secondary coil, which is arranged such that it encloses a portion of a magnetic field and generates, in response, a current for charging a battery of a device, the charger comprising two or more pairs of primary coils, arranged in a circular pattern, whereby the circular pattern is provided so that it surrounds the one or more secondary coils of the devices, as well as an AC power source, which is provided to supply an alternating current to the primary coil pair, the primary coil pairs being subsequently provided with the alternating current in order to generate a rotating magnetic field between respective primary coils of the primary coil pairs. The object of the latter invention is a universal inductive charging unit in which a single primary part can supply a plurality of different secondary parts with electrical energy and an improved magnetic coupling and thus improved efficiency

The disadvantage of this proposal from the prior art is that document EP 2 332 231B1 does not disclose any indications of a method for preventing undesired emissions.

Document EP 2 689 512B1 describes a method for determining power loss in an inductive power transmission system. The method comprises a power transmitter used to inductively transfer power to a power receiver via a transmission coil and a receiving coil. The method comprises the following steps, according to which, in one step, the power emitter receives a power receiving parameter transmitted from the power receiver; and continues to receive chronological information transmitted by the power receiver for chronological matching in order to enable the power emitter to match the time for calculating a power loss to the power receiver during the power transmission; and then calculating the power loss according to the chronological information obtained and the power parameter received.

The disadvantage of this proposal from the prior art is that the document EP 2 689 512B1 also does not disclose any instructions for preventing undesired emissions.

These undesired emissions lead on the one hand in a disadvantageous manner to efficiency losses of the inductive energy transmission devices, but on the other hand also to disadvantageous undesirable heating of metallic objects in the vicinity of the inductive energy transmission devices and furthermore disadvantageously to EMC interference of other devices. In any case, these EMC interferences should be avoided, as they are typically in violation of high-frequency regulations. In the meantime, electromagnetic compatibility is also given special attention by the governing bodies. For example, in publication 19/24557 of the German Parliament, the challenges of EMC are particularly appreciated against the background of the use of higher frequencies and the increasing density of integration. Violations of legal high-frequency regulations typically result in the equipment being taken out of service in order to protect other equipment. Further limitations include, e.g., a prohibition on the further sale of such devices. Furthermore, high costs are to be expected if such restrictions are imposed by the relevant authorities or if penalties are imposed.

Therefore, a need exists for a method for reducing EMC interference emissions while improving transmission efficiency.

### SUMMARY

The object of the invention is therefore to provide a method for reducing EMC interference emissions while improving transmission efficiency.

The present invention of a method for operating a wireless energy transmission device offers the advantage that, using the method according to the invention, in a first step, by means of the measuring element, the at least one measuring device measures a field strength in an air gap between the transmission coil and the receiving coil and, in a further step, the transmission coil control unit sets a working point of the energy transmission, while taking into consideration the field strength value measured by the measuring element, such that a degree of efficiency of the energy transmission device is maximized. In the present context, the term “working point” is understood to mean the setting of the parameters characterizing the transmission, e.g., current and voltage in the transmission coil, but above all the frequency, waveform and, if applicable, also the modulation type. Advantageously, a maximized efficiency is associated with a reduction in undesirable EMC interference emissions. Furthermore, given a maximized efficiency, the consumption of electrical energy is reduced without having to restrict the operation of the powered device.

The method according to the invention for operating a wireless power transmission device with a direct connection of the measuring device to the transmission coil control unit further offers the great advantage that the working point of the power transmission can be immediately set by further elements in the communication path while taking into consideration the field strength value measured by the measuring element without a time delay.

Advantageously, the method according to the invention for operating a wireless energy transmission device having a second measuring device and having a second measuring element offers the advantage that the field strength in the air gap between the transmission coils can be measured not only by a single measuring element. Furthermore, it is advantageous that, in the event of a failure of a measuring element, a second, independent, and redundant measuring device is provided and ensures the operation of the energy transmission device with reduced EMC interference emissions and, at the same time, improved efficiency. Advantageously, the method according to the invention can also enable operation of a wireless transmission device in particularly EMC-sensitive environments with the aid of the second measuring device.

It is particularly advantageous when the first measuring device communicates with the second measuring device in the method according to the invention for operating a wireless energy transmission device. This direct communication is advantageous in order to be able to detect measurement deviations. The measuring devices monitor one another, and this mutual monitoring therefore offers the advantage that the method according to the invention also enables a wireless transmission device to operate in particularly EMC-sensitive environments.

It is advantageous in the method according to the invention for operating a wireless power transmission device when the first measuring device communicates with the second measuring device and when an improved working point can be set with an improved degree of efficiency due to the exchanged readings.

In a particularly advantageous manner, the method according to the invention for operating a wireless energy transmission device having a second measuring device and having a second measuring element offers the advantage that regulatory wireless communication requirements are monitored and complied with. Given that wireless communications regulations remain uniform at the regional or in some cases only at the national level, the method according to the invention offers the advantage of simple adaptation to the respective local requirements. In a particularly advantageous manner, the respective valid requirements of the frequency regulations are chosen by selection of the country or the region. The device can be manufactured in a standard variant and is adapted to the regulatory wireless communication requirements prevailing in the respective market via user selection. No country variants need to be produced or sold in a laborious way.

Advantageously, the method according to the invention for operating a wireless energy transmission device having a second measuring device and having a second measuring element offers the advantage that not only the field strength in the air gap between the transmission coils can be measured. It is advantageous to detect further emissions from the wireless energy transmission device using at least the second measuring device. Such emissions can, e.g., be caused by leads to the coils or by the power-electronic circuits and are not detected solely by the measurement of the field in the air gap between the coils.

It is particularly advantageous to detect further emissions from the electrical device comprising the wireless energy transmission device using the second measuring device. The second measuring device can therefore advantageously also detect emissions by capacitive and/or inductive components, e.g. electric drive motors, and incorporate them into the evaluation. It is therefore advantageously achieved that the electrical device as a whole monitors and complies with regulatory wireless communication requirements. This holistic monitoring provides the advantage that the method according to the invention also enables the secure operation of a wireless transmission device in particularly EMC-sensitive environments.

Furthermore, the method according to the invention offers the great advantage that changes in the field strength in the air gap between the coils caused by interfering metallic objects are detected by the first measuring device having the first measuring element and/or the second measuring element having the second measuring element. In this way, operating situations are advantageously detected in which, on the one hand, undesirable metallic objects reduce efficiency and, on the other hand, there is a risk of these objects being heated in an impermissible manner.

Further features and advantages of the present invention will be apparent to the skilled person based on the following description of exemplary embodiments with reference to the accompanying drawings, but these are not to be construed as limiting the invention.

### BRIEF DESCRIPTION OF THE DRAWINGS

Shown are:

FIG. 1 a wireless energy transmission device having a transmission coil and a receiving coil;

FIG. 2 a wireless energy transmission device having a transmission coil, a receiving coil, and a measuring device having a measuring element;

FIG. 3 a wireless energy transmission device having a transmission coil, a receiving coil, a second measuring device, and having a second measuring element.

All of the drawings are merely schematic representations of the method according to the invention, or the device according to the invention and its components according to exemplary embodiments of the invention. In particular, distances and size relations are not reproduced to scale in the drawings. In the various drawings, corresponding elements are provided with the same reference characters.

### DETAILED DESCRIPTION

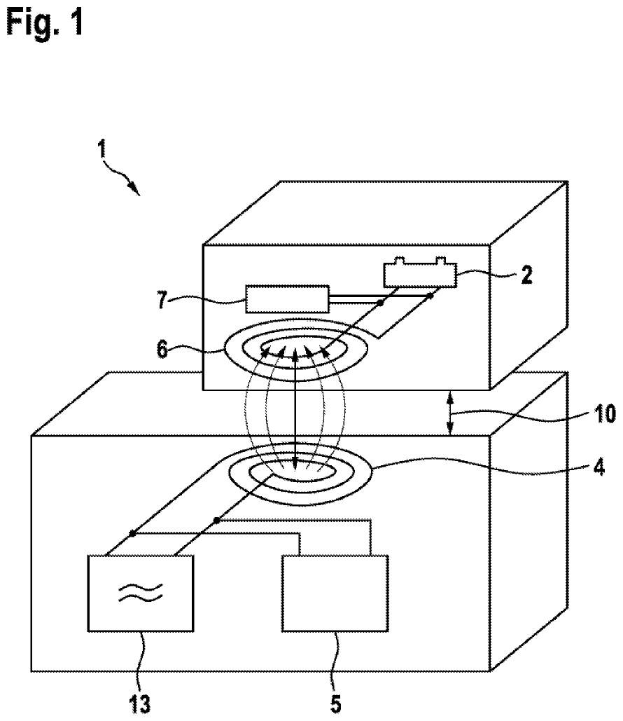

FIG. 1 shows a wireless energy transmission device 1 from the prior art having a transmission coil 4 suitable for inductive energy transmission and a receiving coil 6. FIG. 1 also shows a coil transmission coil unit 5 and a receiving coil control unit 7. The transmission coil 4 is connected to a power source 13. The transmitting unit of the wireless energy transmission device 1 is arranged at a distance from the receiving unit of the wireless energy transmission device 1 via an air gap 10. In addition to the energy transmission, there is also a transmission of information between the transmission coil 4 and the receiving coil 6. This transmission of information can either use the energy transmission of the coils 4, 6 directly on the energy transmission frequency (i.e., what is referred to as in-band data transmission) or take place via the coils 4, 6 on a different frequency (i.e., what is referred to as out-of-band data transmission). Other methods of communication, such as optical communication methods, can also be used. The air gap 10 between the transmission coil 4 and the receiving coil 6 results from the circumstances during the construction of the devices. Given that the transmission coil 4 and the receiving coil 6 are usually each arranged within a device housing, a distance between the transmission coil 4 and the receiving coil 6 already results from the wall thickness of the housing walls, even when the devices are arranged without a further distance from one another, i.e., the housing walls contact one another. By contrast, if the transmission coil 4 is, e.g., installed in a tabletop, then a distance from the transmission coil 4 to the receiving coil 6 is determined by the thickness of the tabletop and by the wall thickness of the housing wall of the receiving unit. This distance is typically called an air gap 10, even if, as in the exemplary cases, not only air but, e.g., housing material or the wood of a tabletop is found in the so-called air gap 10. The consumer supplied with electrical power by the receiving coil 6 can be an electrical energy storage device or other consumer, e.g., an electrical drive of a kitchen device or an electronic device. Given an optimal orientation of the receiving coil 6 in relation to the transmission coil 4, it is possible to achieve a degree of efficiency of the inductive transmission path of significantly more than 90%. An unfavorably enlarged air gap 10 and/or an insufficient orientation of the receiving coil 6 in relation to the transmission coil 4 lead to a large increase in losses, which leads to a sharp increase in undesirable emissions. The air gap 10 can also be enlarged by, e.g., objects between the receiving coil 6 and the transmission coil 4.

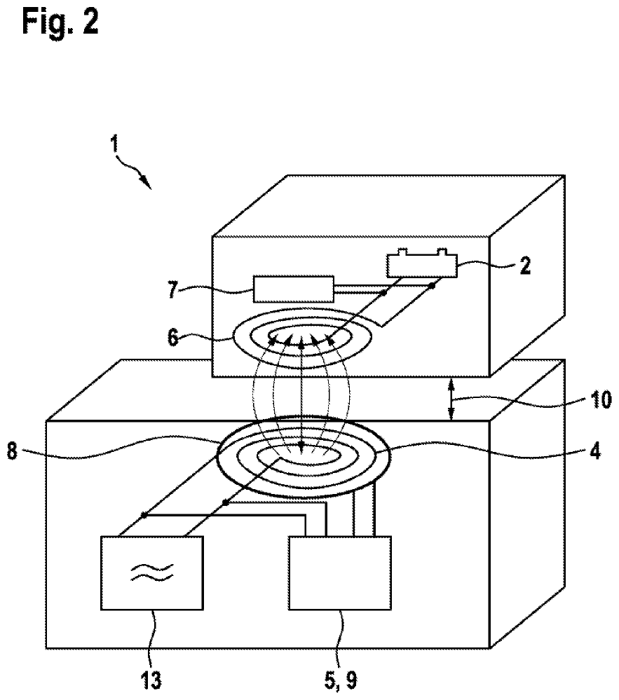

FIG. 2 shows a wireless energy transmission device 1 which, as in FIG. 1, is supplemented by a first measuring element 8. This first measuring element 8 is independent of the transmission coil 4, which is used for the transmission of electrical energy. This additional first measuring element 8 is connected to a first measuring device 9. In FIG. 2, the measuring device 9 is a part of the transmission coil control unit 5. The additional first measuring element 8 can be used in conjunction with the measuring device 9 in order to provide information about the physical properties of the energy transmission on the transmission side. For example, an alternating field whose physical properties are known can be generated via a predefined measurement signal. If the first measuring element 8 now determines physical properties that deviate from this, this indicates, for example, electrically conductive foreign objects in the vicinity of the transmission coil 4. In this case, the use of the transmission coil 4 with a powerful signal suitable for the transmission of energy would lead to undesirable heating of the electrically conductive foreign object due to the generation of eddy currents. Failure to detect this can result in injury or fire. In particular, when installing transmission coils 4 in tabletops or countertops in a hidden manner, the arrangements of inductive transmission coils 4 are not readily discernible. Unmonitored activation of such hidden transmission coils 4 carries the great risk that, e.g., nearby metallic objects are heated and cause injuries or even fires. In addition, such objects substantially interfere with the wireless transmission of electrical power, so that the efficiency of the wireless energy transmission device is reduced. This leads to an increase in the undesired emissions and thus typically to an excess of the legally regulated limit values. Said wireless communications regulation covers the electromagnetic spectrum from 9 kHz to 275 GHz. At an international level, wireless communication regulation is performed by the ITU (International Telecommunication Union). On a regional level, wireless communication regulation is performed by interstate organizations, e.g., the CEPT (Conference Européenne des Administrations des Postes et des Télécommunications). At the national level, wireless communication regulation is performed and implemented, e.g., in the Federal Republic of Germany by the BnetzA (Bundesnetzagentur, Federal Network Agency) on behalf of the Federal Ministry of Economics of the federal government. Essentially, wireless communication regulation covers the use of the available spectrum and the allocation of the usage option to certain user groups. This is also accompanied by the prohibition of use for other user groups. Monitoring the use of the available spectrum in the Federal Republic of Germany is also the responsibility of the Federal Network Agency, which identifies and penalizes unauthorized frequency users. This unauthorized frequency use can be done intentionally by intentionally using unallocated frequencies, but also by undesired and/or unintentional electromagnetic field emissions. The undesired and often also unintentional electromagnetic field emissions on unallocated frequencies leads to interference of other wireless communication services on allocated frequencies and is punishable by law. For this reason, electromagnetic field emissions must in any case be limited so that no interference of other radio services in their assigned spectra results. This can be achieved by an ongoing detection of the electromagnetic fields using the additional first measuring element 8 having the associated first measuring device 9 and a corresponding control of the wireless energy transmission device 1 by the transmission coil control unit 5.

A wireless energy transmission device 1, which is supplemented by a first measuring element 8 having a first measuring device 9, can provide information about the field strength in the air gap 10 of the transmission coil control unit 5 by measuring the field strength in the air gap 10. Based on the measured field strength in the air gap 10, it is possible for the transmission coil control unit 5 to control the transmission coil 4 such that electromagnetic field emissions are reduced so that the degree of efficiency of the wireless energy transmission device 1 is increased. The efficiency optimum of the wireless energy transmission device 1 corresponds to what is referred to as the working point (AP), which is, e.g., indicated in data sheets. A non-fixedly set working point AP has the advantage that it does not simply change uncontrollably due to external influences and other effects, for example aging effects, but rather can be reset according to the respective requirements. In the configuration shown in FIG. 2, this is in particular easily and efficiently possible, because information about the physical state of the wireless transmission device is available with the help of the first measuring element 8 having the first measuring device 9. This information is used to set the working point (AP) at any time.

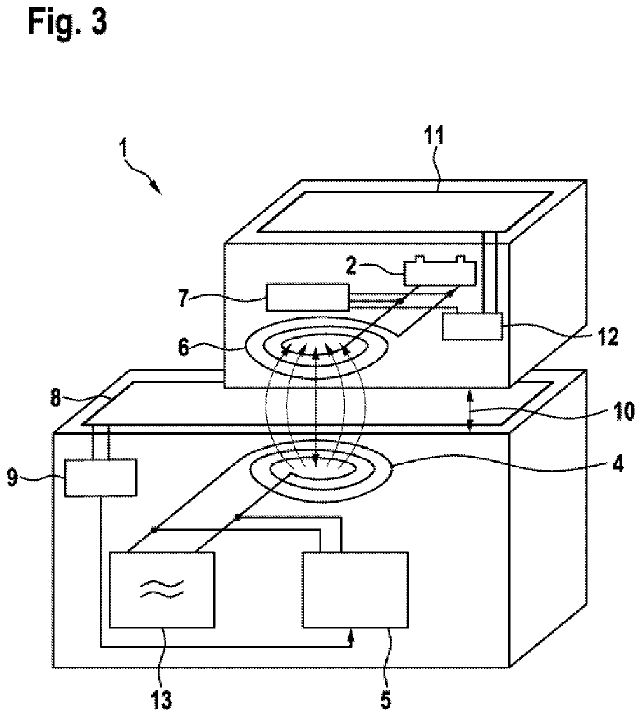

FIG. 3 shows a wireless energy transmission device 1, as in FIGS. 1 and 2, which additionally comprises a second measuring element 11. The additional second measuring element 11 together with the second measuring device 12 serves to detect occurring alternating electromagnetic fields. As a rule, the additional second measuring element 11, together with the second measuring device 12, senses the undesirable emissions transmitted by the wireless energy transmission device 1. Furthermore, the additional second measuring element 11 together with the second measuring device 12 serves to measure the alternating electromagnetic fields emitted from other electrical devices in addition to the wireless energy transmission device 1, e.g. from electric motors.

Information about the emissions behavior is therefore available not only to the wireless energy transmission device 1, but also to the entire device. The information from the additional second measuring element 11 together with the second measuring device 12 serves to operate the entire device in a compliant manner, because emissions beyond the regulated limits of alternating electromagnetic fields are detected, and countermeasures can be initiated, including a complete shutdown of the wireless energy transmission device 1 and other electrical components. The additional second measuring element 11, together with the second measuring device 12, is therefore used to detect increased emissions from alternating electromagnetic fields caused by malfunction and to avoid non-compliant operation. Doing so safely avoids wireless communication interference due exceeding legally regulated limits and avoids punishment due to equipment operating outside of the allowable range.

Furthermore, unexpected changes can be detected by measuring the electromagnetic field of the wireless energy transmission device 1. Such unexpected changes in the electromagnetic field indicate metallic objects in the air gap 10 between the transmission coil 4 and the receiving coil 6. Regarding such a metallic object, eddy currents are generated by the electromagnetic field energy transmission field, which leads to a heating of the metallic object in the air gap 10 between the transmission coil 4 and the receiving coil 6. Such heating can result in injury or fire and must be avoided. The detection of “foreign objects” in the air gap 10 by the ongoing measurement of the electromagnetic field leads to the shutdown of the energy transmission and thus to the elimination of the hazard.

1. A method for operating a wireless energy transmission device (1) for charging an energy storage device (2) of an electric vehicle (3), the wireless energy transmission device (1) including at least one transmission coil (4), which is suitable for an inductive energy transmission and which includes a transmission coil control unit (5), and at least one receiving coil (6), which is suitable for an energy transmission and which includes a receiving coil control unit (7), said wireless transmission device additionally including at least one first measuring element (8) and a first measuring device (9) which is connected to the measuring element (8),
the method comprising,
A. in a first step (A), measuring the field strength in an air gap (10) between the transmission coil (4) and the receiving coil (6) via the at least one measuring device (9) using the measuring element (8) and,
B. in a second step (B), setting a working point (AP) via the transmission coil control unit (5) of the energy transmission while taking into consideration the field strength value measured by the measuring element (8) such that the degree of efficiency of the energy transmission device (1) is maximized.

2. The method for operating a wireless energy transmission device (1) according to claim 1,
wherein,
the first measuring device (9) is connected to the transmission coil control unit (5).

3. The method for operating a wireless energy transmission device (1) according to claim 1,
wherein,
at least one second measuring device (12) is provided with a second measuring element (11) connected to the receiving coil control unit (7).

4. The method for operating a wireless energy transmission device (1) according to claim 1,
wherein,
the at least first measuring device (9) communicates with the at least second measuring device (12).

5. The method for operating a wireless energy transmission device (1) according to claim 1,
wherein,
both the transmission coil control unit (5) and the receiving coil control unit (7) maximize the working point (AP) of the power transmission on the basis of the communication between the first measuring device (9) and the second measuring device (12).

6. The method for operating a wireless energy transmission device (1) according to claim 1,
wherein,
both the transmission coil control unit (5) and the receiving coil control unit (7) set the working point (AP) of the power transmission on the basis of the communication between the first measuring device (9) and the second measuring device (12) such that regulatory wireless communication requirements are complied with.

7. The method for operating a wireless energy transmission device (1) according to claim 1,
wherein,
the second measuring device (12) having the second measuring element (11) detects further emissions by the wireless energy transmission device (1).

8. The method for operating a wireless energy transmission device (1) according to claim 1,
wherein,
the second measuring device (12) having the second measuring element (11) detects further emissions by the electrical device (1), which includes the wireless energy transmission device (1) according to claim 1.

9. The method for operating a wireless energy transmission device (1) according to claim 1,
wherein,
changes in the field strength in the air gap (10) caused by interfering metallic objects are detected by the first measuring device (9) and/or by the second measuring device (12).
